(19) United States
(12) Patent Application Publication
(10) Pub. No.: US 2011/0044417 A1
(43) Pub. Date: Feb. 24, 2011

(54) END OF EINSTEIN-BOHR AND MECHANISMS OF NUCLEAR FORCES: FACILITATED FUSION AND FISSION

(76) Inventor: Yuly Zagyansky, Paris (FR)

Correspondence Address: Zagyansky Y, Entraide 22 Rue Sainte Marthe, Paris, 75010, FR

(21) Appl. No.: 12/310,212

(22) PCT Filed: Sep. 18, 2006
(86) PCT No.: PCT/IB2007/002558

§ 371 Date: Feb. 17, 2009

(30) Foreign Application Priority Data
Sep. 26, 2005 (FR) 05-09792

(51) Int. Cl. G21K 1/00

(52) U.S. Cl. 376/107

(57) ABSTRACT

The Physical Revolution (with End of Einstein-Bohr and PostEinstein-Bohr Physics) continues its numerous convergent confirmations. With general structure of neutron, proton and neutro, I resolved the very concrete mechanisms of “Strong” and “Weak” Nuclear Forces, which are, finally, similar, in basis, to mechanisms of Electromagnetic and Gravitational Forces, resolved by me earlier. Consequently, the use of rays (summary or individual) of particles, which are in origins of these Nuclear Forces, must provoke facilitated nuclear fusions and nuclear fissions, liberating colossal energies, never seen.

### TECHNICAL FIELD OF INVENTION

Invention concerns the simple continuation of utilization of advantages of New Physics developed by me after end of that of postEinstein-Bohr: this time the resolution of mechanism of all Nuclear Forces with consequences like utilization of New Sources of Colossal Energy.

### INTRODUCTION

It appears suspicious for my developments: how, with completely false bases of Einstein-Bohr and postEinstein-Bohr Physics, the World Physics, during one century, made the correct Science, which was in perfect agreement with experiments, producing the important number of Nobel Prizes. It is impossible! But the reality is completely different. These scientists make the great number of Theories with too abstract New Postulates (there is even no the same two articles with the same definitions according to great specialists: which broadness of the Myriad of theories!). And logically when they see an agreement with experiment, they choose justly the convenient theory. Consequently, a “perfect” agreement with experiment is guaranteed. This is confirmed by book of Prof. Pickering [1] [which is rare of objectivity (participating physicist was witness)], stating that this Physics was created superficially with obligatory order (in reality) to follow, established by “geniuses” (for instance, p. 147 of [1]).

It appears as molecular mechanism of Theory of Darwin with changing of conditions. The Life always produces also changing of organisms. And from chaotic arbitrary Mutations (as their “Theories”), one Mutation rests (which satisfies to new conditions) like it was done Exactly and Precisely (for “Experiments”) by Scientific Destiny instead of chaotic mutations in sure reality. Consequently, the incredible but triumphing Falseness (but primed as successes) of Physical Bases could continue the millenniums!! In such “War of Worlds”, fortunately, my proofs [2-5] are TOO evident and SIMPLES and always converging. This last Invention is only the development of Precedent Revolution [2-5]. Consequently, in continuing simply the net New Physics, I established here the New Bases of Nuclear and SubNuclear Physics with their, naturally, too important consequences like New Sources of Energy for milliards of years.

Due to end of Theory of Relativity with incredible grotesque and astonish fantasy of E=mc², the real structure of neutron and proton, with discovery of new particle neutro, was established [2-5] with changing of principles of all equations of Nuclear Physics. Evidently, the New structure of above principal components of nucleus must establish the General Physics of Nucleus and Particles. Clearly, the neutron (with higher molecular weight) contains electron, electronic antineutrino and positron, attached to the new particle neutro (absolutely stable). And proton contains positron, attached to neutro. The clear existence of such neutros is again confirmed by general established fact: the solid presence of “neutrons” in cosmic rays [5a], in spite of classical fact of short lifetime (minutes), where consequently, this particle (hadron) is logically very stable neutro. Evidently, also the antineutron must represent the similar neutron (with the same neutro) but with the inter-changed sites of leptons. The established fact (series of data), that antineutrons (with neutrons) and antiprotons (and protons) can be obtained with help of colliders (evidently after their interaction with nuclei of residual gases—see below) [5b], confirms such structure.

General Structure of Nuclear Interactions. Such general structure of principal nuclear particles permits to make the general structure of all principal interactions in nucleus wherein for such interaction, I shall establish the chain of transformations of particles (like with electromagnetic and gravitational interactions [2-5]), responsible for such (always mutual!!) interactions (titanic nuclear forces). Firstly, there are the interactions between two neutros of two neighbouring, obligingly close!! nucleons (so called main Strong Nuclear Forces must take place and their mechanism is very clearly established here). The number of resting mutual nuclear interactions could be considered (according to unclear definitions) as “Weak” Nuclear Forces that are more numerous together than “Strong” ones. Firstly there are the SHARING interactions between one electron (also the electronic antineutrino that logically situated close to it) with “their” neutron (neutro part) and corresponding empty sites of proton (and part of neutro). It should be the most strong “Weak” interactions that determine general equality between quantity of neutrons and protons in stable nuclei due to such their pair interactions. And also the charge dependent interactions between geometrically relatively close (Interactions in nuclear medium) electrons and positrons of different pairs (neutron-proton) must take place as certainly de facto in very stable α-particles (this must be additionally stabilized only with these charged interactions). And also there are (such) weaker interactions between neighbouring neutrons (at halo) at their excess in heavy nuclei.

“Strong” interactions. It is clear that “Strong” interactions between perfectly neutral neutros must take place with neutral particle transformations (parallel similar chains of matter and antimatter particles) and naturally with logically universal (for such cases) mechanism of creation of silent particle and antiparticle with propagating in a straight line virtual γ-“quanta”, as, justly, it was perfectly proven by me for gravitational forces [4]. Only well approached nucleons (only interaction proton-neutron must take place) can interact with help of such forces (“in medium”: nuclear medium). And such very strong approaching can take place only with help of fitting at one sharing (the same) electron by the same sites of two neutros: of proton and of neutron. That is reflected by fact that “nucleon-nucleon potential contains short-range attractive parts” “that give rise to pairing . . . nuclei” [6] (without their knowledge about above very concrete structure of “Weak” Forces—see below).

And it is the fact that isolated nucleon has the conformation that is different from nucleon, that is in contact with other particles: “pion cannot be absorbed on” only “free nucleon” [7, 8]. Moreover, the neutron (“neutron”) stars (as well interior of planets and Sun) contain principally these free neutros [2-5] as the phase of “infinite nuclear matter” [6], and they represent fluid matter [6], in spite of being even very dense [9]. Again, the presence of numerous nuclei of kaons and pions (but not of other nonimportant particles—see also [10] at nuclear scattering and collisions) [justly main “actors” of nuclear forces—see below] at neutron stars [11-16] provides that with such loss of electron, positron and antineutrino, there is also change of conformation of basic unique nucleon neutro, leading to dissociation of all particles [kaons and pions—(see below)] conducting all nuclear forces. Moreover, one can conclude, that the cause of famous artificial “Nobel” radioactivity (radiation of aluminium 27 with α-rays) [17], is the creation, firstly, of isotope of silicon 31 with positrons (proton lost its positron) which immediately loses its neutron (normally isotope of silicon 31 is stable). This immediate loss of neutron (at stable! “Isotope”) proves that neutro does not have the stabilizing nuclear Internucleon interactions (without corresponding conformational change).

Consequently, only after such forced penetrating approaching of neutron and proton, the neutral interactions (“Strong” Forces) between the same bodies (neutros) of protons and neutrons begin to act. There are sole candidates to conduct such forces: it is the pair (!) (matter, antimatter) of neutral kaons (K°,K°-over-bar). As in the case of gravitational forces [4], these two kaons must be bound in one sole particle (π°—at the surface of nucleons in the case of gravitation and it is again perfectly confirmed with really found decays of neutral pions into muonic neutrino and antineutrino [17a]). This particle really exist: it is phi-meson. Because of this very spread and very global Universal fundamental process, the obtaining of this particle must be very spread and, really!, it is “the machine producing phi-mesons at high rates” [18-21] (with survey on Physics of phi-factories [Refs in 19]).

And there is the real decay of this phi-meson into entangled pair of neutral kaons (K°,K°-over-bar), which even were measured in coincidence (both!) [22-25]. These phi-meson particles are obtained in factories with colliders with beams of electrons-positrons that “interact with residual gas at phi-factories” at “1020” resonance [26,27]. “Classically” [4] such K°,K°-over-bar pairs produce analogous but silent neutre kaon pairs (so called s-goldstinos): K°_{S},K°_{S}-over-bar. These silent kaons classically “interact weakly with ordinary particles, producing γ-virtual “quanta” [28], that propagate with exciting of new K°S,K°_{S}-over-bar [29] in chains of interactions between two very approached nucleons (by neutros parts) as in medium (special nuclear medium!!). And finally “last” K°,K°-over-bar pair again unites in phi (φ)-meson on the surface of another nucleon (destination of chain), strongly attracting it (Equation 1). It is natural that other analogous particle π°, key for gravitational forces, is also produced in simple resonance [Δ resonance (1232)] [30]. Equation 1:

φ→K°,K°-over-bar→K°_{S},K°_{S}-over-bar+γ→ . . . →K°_{S},K°_{S}-over-bar+γ→K°,K°-over-bar→φ

Evidently such kaons (from kaon beams, for instance) could be absorbed in nucleus and moreover they shrink the nucleus [31-35], increasing such “strong” important nuclear forces. Of course, such too important interactions of such spread particles with substance [35a] had to be remarked long time ago. And really, it became even classical [36]. But unfortunately, although naturally, such clear absorption of the beams of these neutral pairs of kaons, in making very heavy contraction of nuclei, redistributes the presence of other particles, responsible for all other “Weak” Nuclear Forces. As consequence, the number of artificial (finally) reactions were measured at absorption of these beams with artificial K°_{L} and K°_{S} (long and short) decays [36]. Only recently, the challenge of these data with symmetry of above “classical” decays was finally done [37].

Weak Forces. These Forces Concern Nuclear Interactions Involving Charged Particles: Electron and Positron and Electronic Antineutrino, Attached to Neutro.

It is generally charged interactions with help of charged kaons and pions. It justly confirms (however) “charge dependence of nuclear interactions” [38]. The rare kaon decays [39-42] play the most essential role in such “Weak” Nuclear Forces and resonances at scattering and absorption of charged pions and kaons [7,17a,33,43-47], reflecting their importance and specificity. Consequently, the excess of charged kaons in nucleus (with their often condensation) provokes also perturbation of nucleus and its shrinkage [32,48-50].

a). Interaction of electron (with its neighbouring antineutrino) with two neutros and of positron with neutro. Negative kaons “in medium”, during electron vibration, are transformed into negative pions with pair neutrino-antineutrino [39-42], which (pair of leptons) classically as at gravitation [4] makes transformation into pair of silent neutrino-antineutrino with virtual γ-“quanta” with consecutive propagation until last step wherein the last interacting couple of these neutral leptons attracts already neutral neutro. Oppositely, the positive kaons, attached to neutro, make analogous chain of propagating transformations with positive pion and pair of neutrino and antineutrino [39-42] until negative electron. Interaction of positron with neutro with also mutual chain of transformations is perfectly analogous. The mechanism of propagation and interaction of these forces is justly analogous to the established mechanism of also charged electromagnetic interactions [2-5]. Evidently in this “charged” case, the pair of positive or negative pions cannot exist because of justly their repulsion. Although clearly, it is not the electronic or pionic pair of neutrinos. Because electronic neutrino participates at electromagnetic interactions outside of nuclear medium and justly these numerous charged kaons and pions in nuclear medium do not have any influence for exterior Coulomb interaction of nucleus with electrons. And because the muonic pair of leptons does not participate in interaction with particles inside of nuclear medium, wherein, as consequence, these interior particles do not weight in nuclear medium (“in medium”), the weight of nucleus is even remarkably less than the sum of its constituent free nucleons [51]. It should be tau pair of neutrino and antineutrino, because the tau neutrino has the nuclear reaction with nucleus with creation of taon and with resonance and “sharp shrinkage of phase space of produced particles” [52,53] and there is also the existence of tau silent (steril) neutrino [54,55]. Or, may be, it could be unknown neutrino-antineutrino pair with similar properties.

b). Interactions between electrons and positrons of neighbouring nucleons. Existence of very stable α-particle proves that there are also charged (Coulomb-like) interactions between neighbouring very close nucleons [9] in nuclear medium (“in medium”) with help of the same transformation of charged kaons into charged pions and pair of neutrino and antineutrino, that justly symmetrically unite two pairs of neutron-proton in opposite positions (“head to tail”).

From Nuclear Forces to General Nuclear Structure and Properties.

Such sharing of electron by corresponding neutro sites of 2 nucleons justly corresponds to well known fact of the most stable structure of nuclei at equality between protons and neutrons [6,56], wherein it follows that at such pairing there is no independent angular momentum [6]. Naturally such sporadic pairing could be found even at “neutron” stars [9]. But there are also nuclei with prevailing quantity of neutrons or protons with their special drip lines [9,56-58]. Pairing of such extra protons (with certainly weaker density) takes place with help of negative kaons chains (with transformations of negative pion) (see above). Wherein consequently the attraction of agglomerations of negative kaons and pions are more dramatic on proton rich nuclei [50]. Normally, the absorption of positive pions increases with the increase of quantity of nucleons in stable nuclei (it means with quantity of neutrons, increased more than proportionally) [9,56-58], that stabilizes (together with negative pions here!) the interaction of pairing neutrons (“head to tail” in this case). Such “halo” with weaker density of pairing excessive neutrons is found around the dense core of nuclei with pairs proton-neutron [9,56,57]. Such neutrons are not only less compact, but also are less stable with their β-decays [56,57].

Of course, such universal propagating chain of reactions of particles in nucleus are properties of nucleus. “The low lying collective surface vibrations” (oscillations) [59-62] of neutro and charged lepton parts of nucleons justly induce the propagating oscillations of particles {mesons in nuclear medium (see above) and neutrinos and antineutrinos (electronic and muonic) at exterior space [2-5] as intuitively (without precise structures), it was felt too [60]} with times of order of hundred of yoctoseconds [58]. So it is not occasionally that main particle “actors” were known already in the fifties. And too numerous particles, described later, must be often artificial.

Evidently, to conduct such developed network of mutual interactions in nucleus and with outside space, the surface structure of nucleus must be very finely structured but not to be simple. So the most powerful decisive experiments with hard electron-nucleon and nucleon-nucleon scattering, sole conducted (“pivotal role”) to the dominating quark theory [63], could be justly interpreted by this fine surface structure! The soft scattering of electrons and positrons was at small angles due to repulsion forces but at analogous scattering with hard (strong) energy conditions, the scattering was equally at large angles [1]. Justly this, Nobel Winners [63] Interpreted as the presence of three small size (independently rotating!) particles (quarks), floating in sea of pions [64, FIG. 10] (this “parton” quark structure, however even with this interpretation, has the terrible contradictions [1]). It justly “resembles” simple scattering of electrons on (also) similar size electrons at all angles [1]. Soft scattering of protons on protons (small angles) and hard analogous scattering at larger angles (although, however, decreasing with increasing of angles [1]) confirms such dependence of angles of scattering on size of target (after passing the electrostatic repulsions due to hard energy).

But justly such fine complex local surface structure of nucleus (to make such numerous delicate functions) makes very simple (without any contradictions about independently moving “seas” [1]!) revolution about falseness of interpretation of very famous Nobel experiments. Of course, the interactions of falling particles, reacting with vibrating surface with complex structure of nucleons, have the resonances. Certainly, there is no “yet” evidence for free particles with fractional electric charge [64a,65] and complete absence of separate quarks (there are only interpretations like even about “pivotal role” of the above) [1] confirms again the pitiful state of fragments of previous Bases: “But how it was even possible” [1]!

Of course, during the oscillations of neutral pions and charged leptons on the surface of one nucleon (neutron), there is the screening (shading) (by other nucleons in nucleus) of interactions taking place due to only directly, spreading (in straight line) virtual “photons” [66] to the exterior space with help of electromagnetic and gravitational forces. These “photons” are created generally as the silent pair with “annihilation” for neutral (generally) forces [67,4] or with transformation of leptons (charged forces) [4].

This shading by particles was introduced and considered with details by me earlier [4]. As result, with increasing of quantity of nucleons in nucleus, its gravitational weight must indicate more and more decreased value (in comparison with weight that has to be due to simple additions). And the negative charge (effect of shading diminishing the effective positive charge of nucleus) makes appearance of increasing at measurements! And justly, this is very clearly established data [51,68-72]. Justly only in the case of such effect of shading with effectively less positive nucleus, the stability of claimed negative “ions” increase with Z (quantity of protons) [68-72] (in reality [YZ], the quantity of electrons perfectly corresponds to number of protons). This is complete “absurd”: the biggest alkaline neutral metal caesium (quantity of electrons is equal to quantity of protons), which, too easily, looses the electron, cannot (at the same time!) have also the very good affinity for new electron to become “negative”: it is already negative, but “effectively”! And only in such reality, all lanthanides are stable (lack of effective positive charge of nucleus) wherein such neutral (in reality) atoms in gas phase are obtained from simple neutral sources like simple evaporations (“metal evaporations”) [68-72]. As I mentioned, the heavy nucleus makes real gravitational interactions weaker than it had to do [51]!

All such extraordinary convergences, explaining all (even fantastical!) experimental facts, point out SuperArchitecture of my triumphing New Physics. Evidently, it is the beginning of New page of Physics: the Cohesion Forces of these Elementary Particles must possess the super-colossal values. Is it possible principally to separate the parts of one particle? In the positive case, the energies of falling particles must be too great, that one can logically obtain with help of my accelerators [4].

Practical Consequences: Artificial Increase (with Known Already Concrete Real Mechanism) of Nuclear Forces Must Provoke the FACILITATED Fusion and Fission with Liberation of Colossal Energy.

Of course, such profound revolutions of Nuclear Physics must conduct to new grandiose sophisticated applications for utilization of Nuclear energy. It is well known that the thermonuclear synthesis of titanic energy does not function yet at industrial scale. But since half of century, the very numerous developments exist, that had to do, so called, cold fusion at temperature that is much lower than that of thermonuclear reaction at Sun [73-76]. To facilitate the reaction, one introduces the very different means of excitation of isotopes of the reaction: tritium and deuterium. These means include: generation of magnetic flow, device for heating, generators of ultrasonic waves, irradiation with light of laser, discharging of high voltage and even electrodes in liquid oxide of deuterium [EP 645777, 477294, 402988, 395066, 394980, 393464, 393465, 1266384, WO 01/63979]. One facilitates nuclear fusion even with help of centripetal compression [WO 95/03611]. Evidently, one can obtain simultaneous excitation by very reactive collisions: for instance in organized plasma with particles of tritium-deuterium (T-D) with mutual collisions [U.S. Pat. No. 4,729,865] or with T and D rays, which meet “face by face” [U.S. Pat. No. 4,650,630]. There is also the very developed machine (“Tokamak”), wherein the plasma is kept in the circle by special toroidal magnetic champ [73, U.S. Pat. No. 5,182,075, U.S. Pat. No. 4,795,605].

The nuclear reactions of synthesis of the above are developed with confinement of particles: magnetic or inertial [due to inertia (of mass) of particles until reaction] [75,76]. This energy of heat can be transformed even directly into electrical one of reactor with help of semiconductors [WO 02/043076, EP 1234309] or evidently with help of stream classically [73]. The transformation of gas into ionized D and T can be effectively done with energy of short pulses of laser [WO 93/11543, EP 615650], wherein this site of transformation can be different from site of reaction of nuclear fusion [EP 393461]. But all these numerous patents for thermonuclear fusion do not function in industrial scale.

Evidently, one can use all these Constructions for reactions of fusion and fission, that are much more efficient due to more profound development of Nuclear Physics of the above with the resolution of action of all Nuclear Forces. For this, one uses the rays of particles that are responsible for such or such Nuclear Forces in directing them on nuclei of fusion or fission (and/or exterior neutron that makes the precedent necessary fusion). For instance, U-238 can have the very facilitated fusion with neutron with consecutive fission wherein there is the fabulous presence of this isotope in nature, usable again without any enrichment. Naturally, the “Strong” Forces between neutro of neutron and nucleon of nucleus of U-238 (rather proton) must be the most important. [One uses, for their amplification, the rays of phi-mesons (K°,K°-over-bar)]. But also the interactions between positrons and electrons of exterior neutron with those of neutron and proton of nucleus must be also important. One uses, for their amplification, the rays of positive and negative kaons. Consequently, for amplifications of nuclear forces, one uses the rays of phi-mesons with rays of positive and negative kaons together, separated or grouped by two. It is from the sum of Combinations of one from 3, of two from 3 and three from 3, that is equal only to 7, that the best results could be chosen. One can also use, together (or as group) or separately, the rays of positive and/or negative pions that are the part of reactions of positive and negative kaons in “Weak” Nuclear Forces (see above).

These rays are easily available from industry. They are not patented, that very clearly proves that the scientists and engineers are TOO far from these REVOLUTIONARY Inventions against all! One can see easily very numerous references: for phi-factories (phi-mesons) in Ref. 17a (resonance phi-1020) (pp. 469-474), for rays of positive and negative kaons in Ref. 17a (resonance 1680) (pp. 512-512) and for rays of positive and negative pions in Ref. 17a (resonance rho 770) (pp. 454-459).

One can find the use of rays of particles and γ-rays even in patents, concerning nuclear fusions and fissions (like WO 98/43249, U.S. Pat. No. 6,654,433, WO 00/072329, EP 1234309).

But one can use these rays in any desired sequence by pulses (normally short). For instance, for necessary precedent fusion of neutron with nucleus of U-238, one can use firstly, the rays of positive kaons (with or without negative kaons) to initiate the creation of pair: neutron (exterior)-proton (with approaching of their neutros according to my mechanism of the above). And AFTER this, one uses the pulse of rays of phi-mesons to diminish again the distance between these nucleons in waiting the following fission.

There is actually only the use of fission of large nucleus like U-235 or Pu-239: chain reaction (after absorption of neutron) of fissions (with creation of new neutrons) with production of colossal energy [77, WO 02/072329, 02/043076, EP 1234309, 1350355]. Wherein the enrichment of U-235 or the transformation of U-238 into Pu-239 are very expensive.

### REFERENCES

1. Pickering, A “Constructing Quarks. A sociological history of particle physics”, Edinbourg, Univ. Press, 1984.
2. Zagyansky, Y Publication PCT: WO 99/56288 (1999).
3. Zagyansky, Y Publication PCT: WO 00/056288 (2000).
4. Zagyansky, Y Publication PCT: WO 03/084301 (2003).
5. Zagyansky Y French Application N^{o} 03-14703 (2003).
5a. Thorne M C J Radiol Protect. 23, 29-32, 2003; Kornmayer, H et al J Phys G 21, 439-449, 1995.
5b. Bressani, T & Filippi, A Phys Rep 383, 213-297, 2003; Bilenkaya, S I et al Nuovo Cimento 105A, 1421-1433, 1992.
6. Dean D J & Hjorth-Jensen M Rev Mod Phys 75, 607-656, 2003.
7. Lee, T S H & Redwine, R P Annu Rev Nucl Part Phys 52, 23-63, 2002.
8. McKeown, R D et al Phys Rev Lett. 44, 1033-1036, 1980.
9. Weber F J J Phys G 25, R195-229, 1999.
10. Landua, R. Annu Rev Nucl Part Sci 46, 351-93, 1996.
11. Muto, T Progr Theor Phys Suppl 153, 174-189, 2004.
12. Kishimota, T et al Progr Theor Phys Suppl 149, 264-74, 2003.
13. Prakash M et al Phys Rep 280, 1-78, 1997.
14. Yakovlev D G & Pethick C J Annu Rev Astr Astrophys 42, 169-210, 2004.
15. Heiselberg, H & Hjorth-Jensen M Phys Rep 328, 237-327, 2000.
16. Pal, S, Bandyopadhyay, D & Greiner, W Nucl Phys A 674, 553-77, 2000.
17. Perrin F “The discovery of radioactivity beta positive” in “Artificial radioactivity has 50 years” pp. 55-58, Les Editions de Physique, Les Ulis, 1984.
17a. “Review of Particle Physics”, Phys Rev D 66, N^{o} 1, 2002.
18. Benatti, F & Floreanini R Nucl Phys B 511, 550-576, 1988.
19. Bramon, A, Garbarino G & Hiesmayr B C Phys Rev A 69, 062111+, 2004.
20. Ancochea B, Bramon A & Nowakowski M Phys Rev D 60, 094008+, 1999.
21. Dass G V & Grimus W Phys Lett B 521, 267-72, 2001.
22. Nauenberg, P M Phys Lett B 447, 23-30, 1999.
23. Bramon, A & Garbarino G Phys Rev Lett 88, 040403+, 2002.
24. Ishiwatari, T et all Phys Lett B 593, 48-54, 2004.
25. Urbanowski, K Modern Phys Lett 19, 481-496, 2004.
26. Achasov, M N, Achasov, N N, Golubev, V B & Serednyakov S I Phys Lett B 404, 173-178, 1997.
27. Achasov M N et al JETP Lett 67, 777-780, 1998.
28. Gorbunov, D S & Rubakov, V A Phys Rev D 64, 054008+, 2001.
29. Diehl, M, Krole P & Vogt C Phys Lett 532, 99-110, 2002.
30. Biselli, A et al Phys Rev C 68, 0352002+, 2003.
31. Dote, A et all Progr Theor Phys Suppl 146, 508-513, 2002.
32. Alcaishi, Y, Dote, A & Yamazaki T Progr Theor Phys Suppl 149, 221-232, 2003.
33. Dote, A, AZkaishi, Y & Yamazaki T Nucl Phys A 738, 372-376, 2004.
33a. Machnik, S G et al Phys Rev C 61, 034601+, 2000.
34. Kunihoro, T Progr Theor Phys Suppl 153, 15-25, 2004.
35. Yamazaki, T, Dote, A & Akaishi, Y Nucl Phys A 738, 168-174, 2004.
35a. Benatti, F, Floreanini R & Romano R Phys Rev D 68, 094007+, 2003
36. Feyman, R <<The course of Physics of Feyman>> vol. 3, Interéditions, Paris, 1979.
37. Ceccucci, A Int Mod Phys A 19, 889-906, 2004.
38. Machleldt, R & Slaus, I J Phys 27, R69-R108, 2001
39. Gao, D N Phys Rev D 69, 094030+, 2004.
40. Gao, D N Phys Rev D 67, 074028+, 2003.
41. Landsberg L G Physics Uspechi 46, 995-1051, 2003.
42. Landsberg L G Phys Atom Nucl 65, 1747-1770, 2002.
42a. Grossman, Y Int J Mod Phys A 19, 907-917, 2004; Buchalla, G & Buras, A J Phys Rev D54, 6782-6789, 1996.
43. NEPAL “Travelling to the heart of matter”, Belin, CNRS, Paris, 2002.
44. Laue, F et al Phys Rev Lett 82, 1640-1644, 1999.
45. Mack, D J et al Phys Rev C 45, 1767-1783, 1992.
46. Ivanov, A N et al Eur Phys J A 21, 1-28, 2004.
47. Akhmetshin, R R et al Phys Lett B 527, 161-172, 2002.
48. Dote et al Phys Lett B 590, 51-56, 2004.
49. Akalshi, Y & Yamazaki T Phys Rev C 65, 044055+, 2002.
50. Kunihiro, T Progr Theor Phys Suppl 153, 15-25, 2004.
51. Lunney, D et al Rev Mod Phys 75, 1021-1082, 2003.
52. Starkov, N I J Phys G 27, L81-L85, 2001.
53. Hagiwara, K, Mawatari, K & Vokoy, H Nucl Phys A 668, 364-384, 2003.
54. Chun, L A & Song J Nucl Phys B 598, 3-12, 2001.
55. Faessler, A Springer Tracts Modern Phys 163, 1-14, 2000.
56. Hinde, D & Dasgupta M Nature 431, 748-750, 2004.
57. Johnson, B Phys Rep 389, 1-59, 2004.
58. Thoennessen, M Rep Progr Phys 67, 1187-1232, 2004.
59. Balso, A et al Phys Rep 391, 261-310, 2004.
60. Beuthe, M Phys Rep 375, 105-218, 2003.
61. Barranco, F et al Phys Rev Lett 83, 2147-2150, 1999; Lacroix, D et al Progr Part Nucl Phys 52, 497-563, 2004.
62. Gori, G Acta Phys Pol 32, 767-771, 2001.
63. Friedman, J I Annal Phys 10, 109-121, 2001.
64. Taylor, RE Phil Trans Royal Soc Lond A 359, 225-240, 2001.
64a. Smith, P F Annu Rev Nucl Part Phys 39, 73-111, 1989.
65. Lee I T et al Phys Rev D 66, 012002+, 2002.
66. Whalley, U R J Phys 27, A1-A121, 2001.
67. Piotto, E Int J Mod Phys A 16, 790-792, 2001.
68. Andersen T Phys Rep 394, 157-313, 2004.
69. Vosko S H, Lagowski, B & Mayer, I L Phys Rev A 39, 446-449, 1989.
70. Andersen, T et al J Phys 30, 3317-3332, 1997.
71. Andersen T et al J Phys Chem Ref Data 28, 1511-1533, 1999.
72. Pegg D G Rep Progr Phys 67, 857-905, 2004.
73. “Nuclear Fusion” vol. 12 (pp. 154-167), McGrow Hill Encyclopedia of Science and Technology, 8^{th} Ed., 1997.
74. “Nuclear reactions” ibid (pp. 183-197).
75. Adam J “The nuclear fusion: one source of energy for future”, Pour la Science, Paris, 1993.
76. Weisse, J “The nuclear fusion”, PUF, Paris, 2003.
77. “Nuclear fission”, vol. 12 (pp. 139-145), McGrow Hill Encyclopedia of Science and Technology, 8^{th} Ed., 1997.

For Basic original Application (PCT/IB00/00843) “End of Einstein-Bohr . . . ”, exemplary Complete Search of Invention as a whole (Scientific theories with their Application) was done by ISA and certainly Led to VALID Patents for such analogous application. Many converging proofs for New Physics.

According to Rule 39.1 (i) [67.1(i)] PCT explained specially with reference in §9.05 (“PCT Guidelines”): “When viewing the claims as whole, if theories are applied or implemented to produce a practical application . . . . Search and Preliminary Examination is required”. The executed complete Search (PCT/IB00/00843, “PCT Gazette” 412001) surely confirms that scientific theories were indeed Searched only because of their industrial applications, that are moreover perfectly feasible (§CII-4.11 “EPO Guidelines”: otherwise (if not feasible) the Invention is not “susceptible of industrial application”). Without doubt such exemplary complete, accepted by Highest EPO Authority, Search (absolutely, new, absolutely inventive and utile) was leading to exemplary (even by European Patent Office) National Examinations and Patents [Art. 35(2), Rule 70.6 PCT, afterwards §EIX-6.4.3 “EPO Guidelines” with Art. 96(2) with Rule 51(3) EPC]. Of course, if Search and Examination are exemplary positive for searched scientific theories due to real industrial applications (see above), for what must Complete Search be done. It certainly means that the ensemble must be patented for 100% too.

With excellent convergence, all numerous developments with above Basic (PCT/IB00/00843) Work (PCT/IB03103315, PCT/FR05/02987—almost identical to this Application) confirm the validity of New Physics [as clear direct error of Great Schrodinger in his famous Equation; practically complete crossing of Sun by cosmic “rays (particles!) only (any other explanation is simply impossible!) due to value of speeds higher than that of light (and of electric field!); Uncontradictable Process of General Cosmogony (creation and evolution of Universes, Galaxies, Solar Systems); convergent development of mechanism of all Physical Forces with justly corresponding existing “personal” elementary particles (and many other confirmations as for instance mechanism of Earthquakes and Sun Spots Cycles, radiation excess in Universe, coplanarity of all Solar Systems and Galaxies). Let us remind that Theory of Relativity was accepted after only sole experiment at Sun eclipse, considering as confirmation of only one consequence of Einstein's Theory.

But, even from beginning (PCT/IB00/00843, PCT/IB03103315), the End of Theory of Relativity was surely proven by me with detailed mathematical converging calculations based on new and inventive physical considerations, never even remarked by any genius of XX century. It was end of famous Nobel Michelson experiment [that justly contradicted to all previous Classical Physics (Mechanics)], without which the main Postulate of Einstein's Theory does not exist, making already its Theory as unexisting!!! Moreover, with my Physics and my correct calculations, this famous Nobel experiment became already the confirmation of Classical Mechanics!! Justly for this (already) calculated END of Einstein's Theory, Prof. Holland, Theoretical Physicist, author of professional books, Editor of 3578 articles, wrote, consequently, that it is “great interest”, necessary for “foundations of Physics”. This my last smaller Application is finally the consequence of such developed End of Theory of Relativity with end of famous Equation E=mc².

1. The General Structure of Nucleus, constructed from Nucleons, is characterized by following characteristics (features) [Rule 63 (b) (ii) PCT]:
a). The neutro is the carcase part of all Nucleons (Neutrons and Protons) and there are the specialized sites for interactions with electron, electronic antineutrino and positron, wherein the neutron is constituted by integration of all these particles on neutro and proton is constituted by integration of only positron.
b). All nuclear interactions are mutual and take place in nuclear medium and are conducted with help of permanent frequent vibrations (oscillations), provoking the transformations of elementary particles which propagate directly in a straight line with such general mechanism.
c). The interaction of two sites for electron of two neutros: of neutron (occupied) and of proton (free) provokes the very penetrating approaching (pair interaction!) of neutron and proton, which surmounts the repulsion forces and switches the “Strong” Nuclear Forces between these two neutros, wherein consequently the most stable nuclei (of pairs) have similar quantities of neutrons and protons (in pairs).
d). The “Strong” Nuclear Force between neutros is produced from the surface of neutro: phi-meson, on surface of one neutron, transforms into two neutral kaons (particle and antiparticle), which transform into two neutral silent (sterile) kaons (particle and antiparticle) with γ-“quanta” (logically virtual), which propagates in a straight line with this “quanta” mechanism until last pair of neutral kaons (near another neutron), that transforms into phi-meson on surface of another neutro.
e). The “Weak” Nuclear Force (always mutual) of electron of neutron in direction of its neutro is produced after induction (by electron vibrations) of transformation of negative kaon into pion with neutrino and antineutrino (logically tau ones), which transform into those silent (sterile) neutrino and antineutrino with γ-“guanta”, which propagate in a straight line and wherein the last interacting couple of these neutral leptons attracts already neutral neutro, perfectly confirming the mechanism, wherein the analogous force of positron (of neutron or of proton) in direction of neutro has the similar mechanism (with positive kaons).
f). The “Weak” Nuclear Force of neutro in direction of its electron of neutron (and of neutro in direction of its positron of proton or of neutron) is produced analogically to that mutual of electron of neutron in direction of neutro, but with transformation of positive kaon here, near surface of neutro, into positive pion and two neutrinos with last phase of attraction of positive kaon by electron (and analogically with transformation of negative kaon of the case of “Weak” Nuclear Force of neutro in direction of its positron of proton or of neutron).
g). The α-particle (constituted from two neutron-proton pairs, that are situated as “head-tail”) is well stabilized by charged interactions between leptons on different nucleons with help of transformations of charged kaons like in “Weak” Forces, wherein such mechanism can stabilize the nucleus by these interactions between different pairs (and even nucleons).

2. The nuclear fusion and fission (like fusion of neutron with consecutive fission of Uranium-238) are characterized in that they must be provoked (facilitated) with all rays together (or grouped or separated) of particles participating in Nuclear Forces according to claim 1, notably, with (1) totality of rays of neutral phi-mesons and positive kaons and negative kaons or (2) separately the neutral phi-mesons or positive kaons or those negative ones, or (3) the neutral phi-mesons with positive kaons or (4) the neutral phi-mesons with negative kaons or (5) positive kaons and negative kaons.

3. The provoked (facilitated) Nuclear fusion and fission according to claim 2 are characterized in that one can use the combinations of these rays in any desired sequence (normally with short pulses) [like with fission of Uranium-238: for instance, firstly, the pulse of rays of positive kaons (with or without those negative) to approach the pair of exterior neutron with proton and after with pulse of rays of phi-mesons to approach their neutros consequently].

4. The provocation (facilitation) of nuclear fusion and fission are characterized in that the rays of positive and/or negative pions, which participate in transformations of positive and negative kaons in “Weak” Nuclear Forces according to claim 1, can help to this provocation (facilitation) of nuclear fusion and fission.

5. The provocation (facilitation) of fusion and fission of claim 4 characterized in that one can use these rays of positive and/or negative pions by separated pulses (normally short), with other rays and in desired moment of these fusions and fissions.
